(19) United States
(12) Patent Application Publication
(10) Pub. No.: US 2006/0275097 A1
(43) Pub. Date: Dec. 7, 2006

(54) Pull nail with chamfered surface head portion

(76) Inventor: To-Ha Loi, Dandenong South (AU)

Correspondence Address: To-Ha Loi, Box 8-24, 235 Chung-Ho, Taipei, TW

(21) Appl. No.: 11/141,133

(22) Filed: Jun. 1, 2005

(51) Int. Cl. F16B 13/04

(52) U.S. Cl. 411/29

(57) ABSTRACT

A pull nail comprises a pull rod; a sleeve; the pull rod being enclosed by the sleeve; a sharp tapered head is formed at one end of the pull rod; one end of the sharp tapered head being connected to the pull rod and another end of the sharp tapered head being formed with a chamfered surface; and a neck formed between the sharp tapered head and the sleeve; one end of the sleeve resisting against the sharp tapered head and another end thereof being formed with an annular lip.

### FIELD OF THE INVENTION

The present invention relates to pull nails, and particularly to a pull nail with a chamfered surface at a head portion which makes the user of the pull nail drill an object easy and convenient.

### BACKGROUND OF THE INVENTION

Referring to FIG. 1, the pull nail of the present invention comprises the following elements. A pull rod 10 is enclosed by the sleeve 20. A round tapered head is formed at one end of the pull rod 10. One end of the round tapered head 11 is connected to the pull rod 50. A neck 12 is formed between the round tapered head 11 and the sleeve 20. One end of the sleeve 20 resists against the round tapered head he and another end thereof is formed with an annular lip 21.

In operation, one end of the pull rod 10 far away from the round tapered head 11 is connected to a driving tool 40 which can clamp the pull rod 20 and rotate the pull rod 10 with high speeds. When combing two plates 30A, 30B, the plates are drilled with respective penetrating holes 31A and 31B. The sleeve 20 insert into the holes 31A, 31B. The annular lip 21 resists the upper plate 30A. The tool 40 pulls one end of the pull rod 20 until the pull rod 520 breaks from the neck 12 (referring to FIG. 2). Then the sleeve 20 will be extruded to expand and deform, see FIG. 3, so as to form an annular lip 22 to resist against another plate 30B, as shown in FIG. 4. Thereby the plates 30A and 3B are combined.

However although the prior art has the effect of combining the two plates 30A, 30B, the operation can not be performed easily and successfully due to the design the pull nail. Thereby there is an eager demand for a novel one which can improve the defect in the prior art.

### SUMMARY OF THE INVENTION

Accordingly, the primary object of the present invention is to provide a pull nail which make the use of the pull nail easy and convenient.

To achieve above object, the present invention provides a pull nail. The pull nail comprises a pull rod; a sleeve; the pull rod being enclosed by the sleeve; a tapered head is formed at one end of the pull rod; one end of the tapered head being connected to the pull rod and another end of the tapered head being formed with a chamfered surface; and a neck formed between the tapered head and the sleeve; one end of the sleeve resisting against the tapered head and another end thereof being formed with an annular lip.

The various objects and advantages of the present invention will be more readily understood from the following detailed description when read in conjunction with the appended drawing.

### BRIEF DESCRIPTION OF THE DRAWINGS

FIG. 1 is a cross sectional view showing the application of a prior art pull nail.

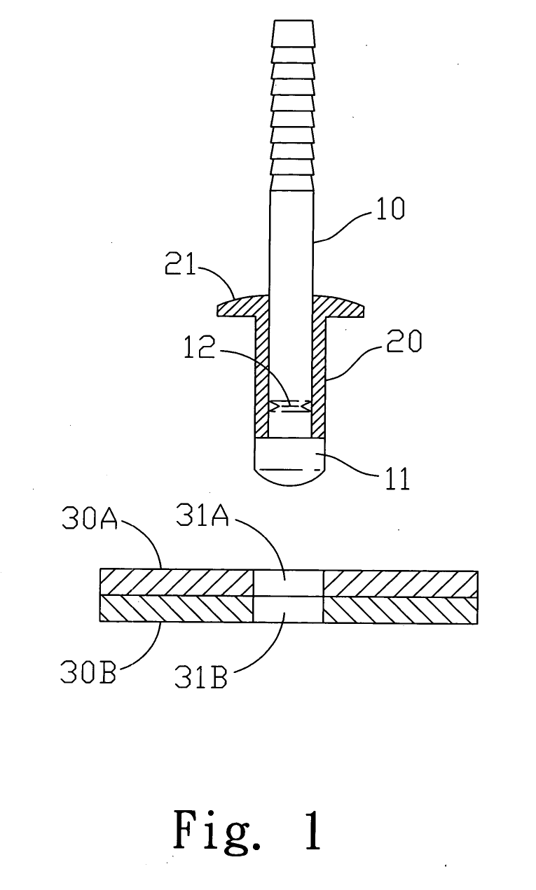

FIG. 2 is a schematic view of the prior art pull nail.

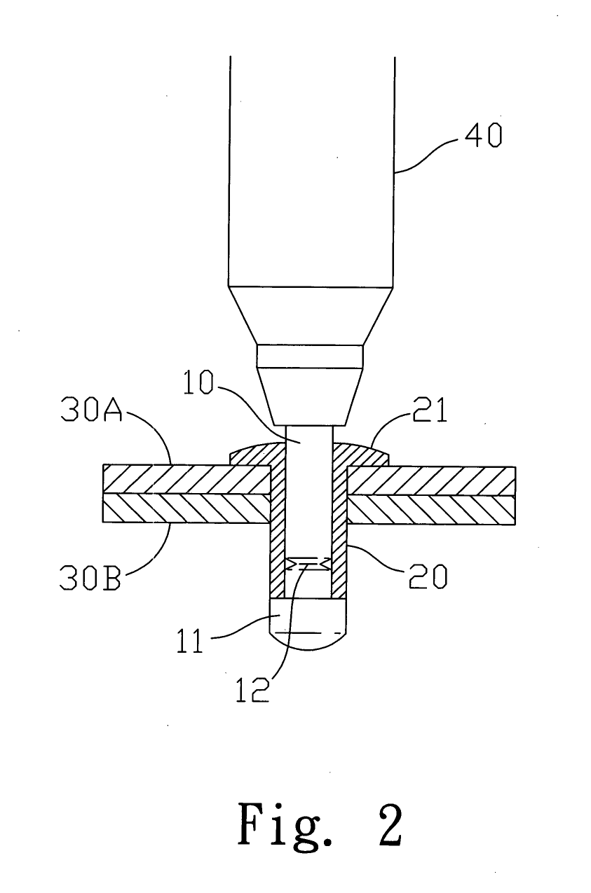

FIG. 3 is another schematic view of the prior art pull nail.

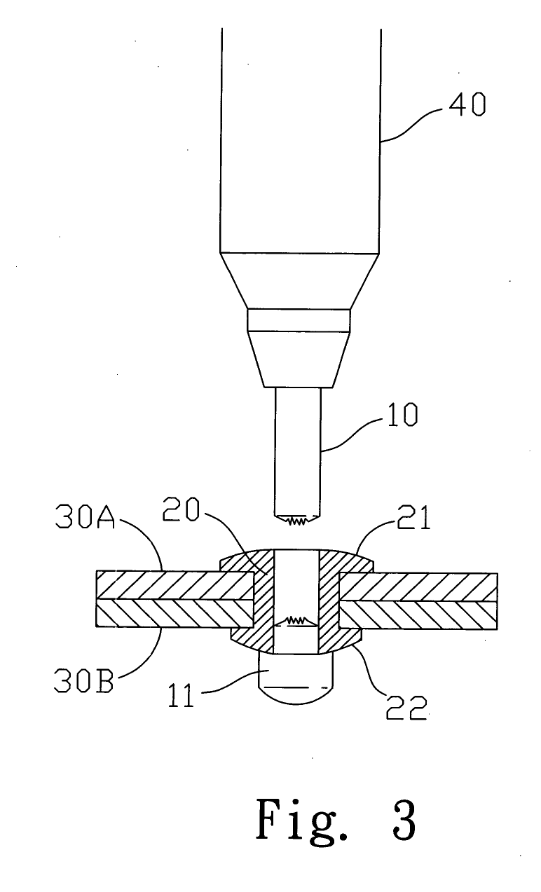

FIG. 4 is a further schematic view of the prior art pull nail.

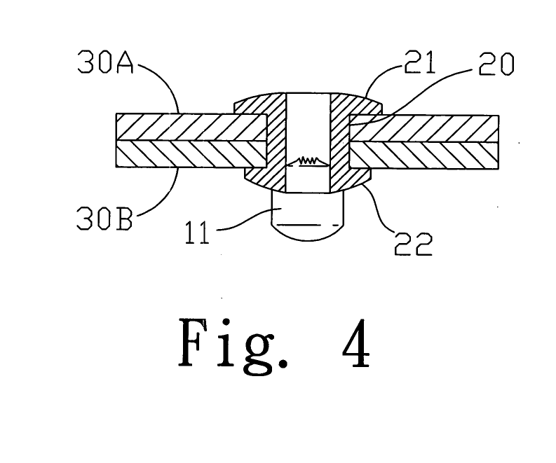

FIG. 5 is a schematic view about the application of the pull nail of the present invention.

FIG. 6 is another schematic view of the present invention.

FIG. 7 is a further schematic view of the present invention.

FIG. 8 is a yet schematic view of the present invention.

### DETAILED DESCRIPTION OF THE INVENTION

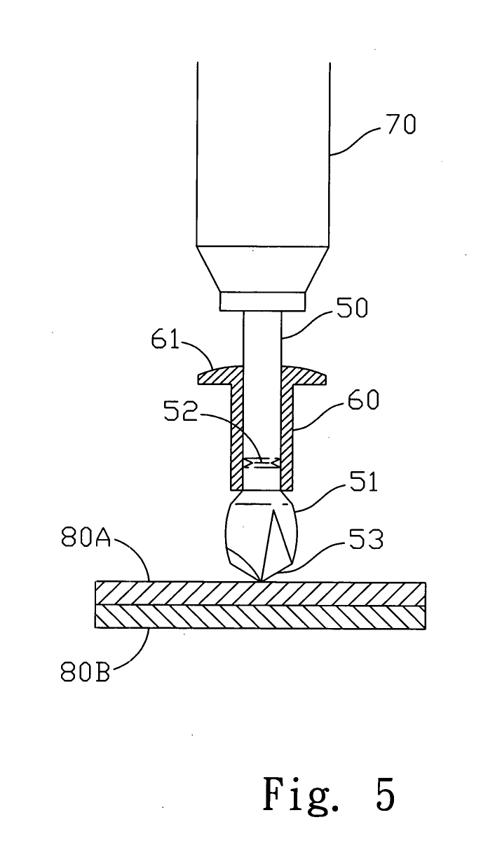

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims. With reference to FIGS. 5 to 8, the present invention will be described herein.

Referring to FIG. 5, the pull nail of the present invention comprises the following elements.

A pull rod 50 is enclosed by a sleeve 60.

A sharp tapered head 51 is formed at one end of the pull rod 50. One end of the tapered head is connected to the pull rod 50 and another end of the sharp tapered head 51 is formed with a chamfered surface 53.

A neck 51 is formed between the sharp tapered head 51 and the sleeve 60. One end of the sleeve 60 resists against the tapered head 51 and another end thereof is formed with an annular lip 61.

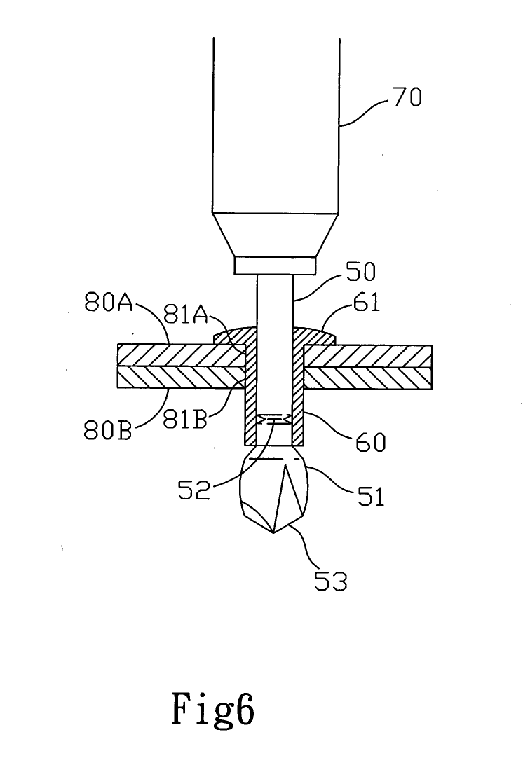

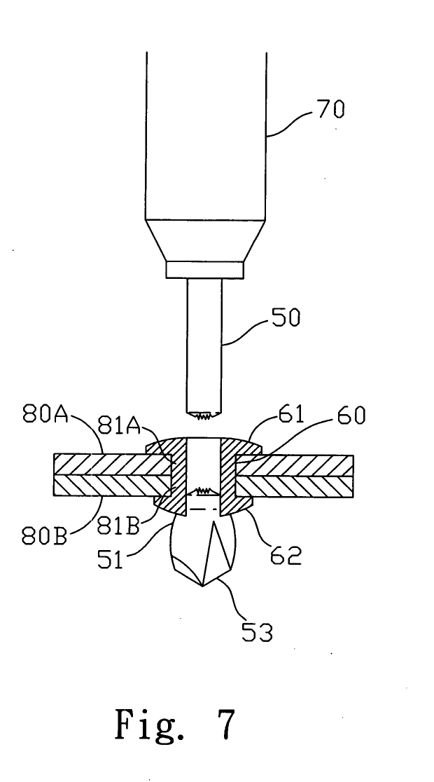

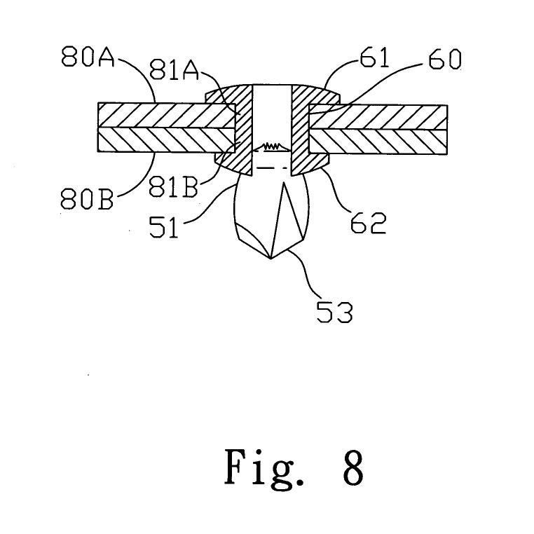

In operation, one end of the pull rod 50 far away from the tapered head 51 is connected to a dedicated pneumatic or electromotive tool 70 which can clamp the pull rod 50 and rotate the pull rod 50 with high speeds. When combing two plates 80A, 80B, the plates are drilled with respective penetrating holes 81A and 81B. The sleeve 60 inserts into the holes 81A, 81B. The annular lip 61 resists the upper plate 80A, as shown in FIG. 6. The tool 70 pulls one end of the pull rod 50 until the pull rod 50 breaks from the neck 52 (referring to FIG. 7). Then the sleeve 60 will be extruded and thus it expands and deforms to form an annular lip 62 to resist against another plate 80B, as shown in FIG. 8. Thereby the plates 80A and 8B are combined.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A pull nail comprising:
a pull rod;
a sleeve; the pull rod being enclosed by the sleeve;
a sharp tapered head is formed at one end of the pull rod; one end of the sharp tapered head being connected to the pull rod and another end of the sharp tapered head being formed with a chamfered surface
a neck formed between the sharp tapered head and the sleeve; one end of the sleeve resisting against the sharp tapered head and another end thereof being formed with an annular lip.
